(19) United States
(12) Patent Application Publication
(10) Pub. No.: US 2013/0139180 A1
(43) Pub. Date: May 30, 2013

(54) SERVER APPARATUS, PROGRAM, AND INFORMATION TERMINAL

(71) Applicant: SONY CORPORATION, Tokyo (JP)

(72) Inventors: Hideo Nagasaka, Kanagawa (JP); Tomonori Misawa, Tokyo (JP)

(73) Assignee: SONY CORPORATION, Tokyo (JP)

(21) Appl. No.: 13/681,856

(22) Filed: Nov. 20, 2012

(30) Foreign Application Priority Data
Nov. 30, 2011 (JP) 2011-261708

(51) Int. Cl. G06F 9/44

(52) U.S. Cl. CPC G06F 9/44
USPC 719/318

(57) ABSTRACT

A server apparatus which may include an event-information receiver configured to receive information from an information terminal, in which the information may identify an event in which a user of the information terminal wishes to join. The server apparatus may further include an application recommending unit configured to recommend, when receiving the information identifying the event, to the user of the information terminal that the information terminal execute one or more event-related applications at timings when the event-related applications are available, respectively, in which the one or more event-related applications may relate to the event in which the user wishes to join.

### BACKGROUND

The present disclosure relates to a server apparatus, a program, and an information terminal.

In recent years, many applications, which information terminals are capable of using, are provided via networks such as the Internet. Examples of the information terminals include smartphones, tablet computers, mobile phones, personal computers, and the like. The number of applications provided via networks is extremely large, and is growing every day. It is difficult for an individual user to select applications according to the user's needs, to know content of each application, and to know processing that each application is capable of executing. In view of this, there are provided technologies, which recommend applications according to users' needs (for example, see Japanese Patent Application Laid-open No. 2010-157207, 2011-113401, and 2011-90391).

### SUMMARY

For example, Japanese Patent Application Laid-open No. 2010-157207 discloses the following technology. That is, when an application is being used, other applications are recommended. The recommended applications relate to the application being used. More specifically, Japanese Patent Application Laid-open No. 2010-157207 discloses the following technology. That is, for example, when an image-viewer application is being used, related-applications are recommended. The related-applications are applications for editing images, for managing images, and the like. Specific examples of the related-applications include an image-editing application, an image-upload-service application, and the like.

According to the technology of Japanese Patent Application Laid-open No. 2010-157207, applications are recommended only when another application is being used. However, it is desirable to improve this kind of technology. For example, if applications, which may be used in the future, are previously recommended, the user-friendliness is further improved.

In view of the above-mentioned circumstances, it is desirable to recommend an application according to a user's needs at a user-friendly timing.

According to an embodiment of the present technology, there is provided a server apparatus, including: an event-information receiver configured to receive information from an information terminal, the information identifying an event in which a user of the information terminal wishes to join; and an application recommending unit configured to recommend, when receiving the information identifying the event, to the user of the information terminal that the information terminal execute one or more event-related applications at timings when the event-related applications are available, respectively, the one or more event-related applications relating to the event in which the user wishes to join.

The application recommending unit may be configured to provide a scheduler application to the information terminal, the scheduler application causing the information terminal to recommend, when receiving the information identifying the event, to the user of the information terminal that the information terminal execute one or more event-related applications at timings when the event-related applications are available, respectively, the one or more event-related applications relating to the event in which the user wishes to join.

The application recommending unit may be configured to send information on the one or more event-related applications and the scheduler application to the information terminal, and to reply the scheduler application in response to an obtaining request from the information terminal.

The scheduler application may be a program causing the information terminal to display options, the options corresponding to the one or more event-related applications, respectively, and to display options in a manner that the user is capable of identifying the options, the options corresponding to an available event-related application.

The scheduler application may be a program causing the information terminal to set, in a case where available hours of the plurality of event-related applications overlap one another, priority numbers for the plurality of event-related applications, and to display the priority numbers explicitly.

According to an embodiment of the present technology, there is provided a program causing a computer to function as: an event-information receiver configured to receive information from an information terminal, the information identifying an event in which a user of the information terminal wishes to join; and an application recommending unit configured to recommend, when receiving the information identifying the event, to the user of the information terminal that the information terminal execute one or more event-related applications at timings when the event-related applications are available, respectively, the one or more event-related applications relating to the event in which the user wishes to join.

According to an embodiment of the present technology, there is provided an information terminal, including: an event-information sending unit configured to send information to a server apparatus, the information identifying an event in which a user of the information terminal wishes to join, the server apparatus including an application recommending unit, the application recommending unit being configured to recommend, when receiving the information identifying the event in which the user of the information terminal wishes to join from the information terminal, to the user of the information terminal that the information terminal execute one or more event-related applications at timings when the event-related applications are available, respectively, the one or more event-related applications relating to the event in which the user wishes to join; and an application providing unit configured to provide information on the one or more event-related applications to the user, the one or more event-related applications being recommended by the server apparatus in response to sending of the information identifying the event in which the user wishes to join.

As described above, according to the present technology, an application may be recommended according to a user's needs at a user-friendly timing.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram for the background of a first embodiment;

FIG. 2 is a diagram for explaining the outline of the first embodiment;

FIG. 3 is a diagram showing the configuration of an information processing system of the first embodiment;

FIG. 4 is a block diagram showing the functional configuration of an information terminal of FIG. 3;

FIG. 5 is a diagram showing a specific example of a display mode of an event list;

FIG. 6 is a block diagram showing the functional configuration of an application manager server of FIG. 3;

FIG. 7 is a diagram showing an application-manager table;

FIG. 8 is a diagram showing a specific example of a display mode of an application list;

FIG. 9 is a sequence diagram showing how the information terminal and the server apparatus of FIG. 3 work;

FIG. 10 is a block diagram showing the hardware configuration of the information terminal of FIG. 3;

FIG. 11 is a diagram showing a modified example of the display mode of the application list;

FIG. 12 is a diagram showing another modified example of the display mode of the application list;

FIG. 13 is a diagram showing another modified example of the display mode of the application list;

FIG. 14 is a block diagram showing the functional configuration of an information terminal of a second embodiment.

### DETAILED DESCRIPTION OF EMBODIMENTS

Hereinafter, an embodiment of the present disclosure will be described with reference to the drawings.

### First Embodiment

### [Outline of First Embodiment]

A scheduled event is simply referred to as an “event” in this specification. Examples of such an event include a broadcast program, a concert, a cinema, a fireworks show, a festival, and the like. In relation to an event, in which a user of an information terminal wishes to join, the user may wish to use various applications. Similarly, in relation to an event, in which the user joined, the user may wish to use various applications.

For example, a user uses applications as follows.

1. If a user wishes to record a broadcast program, the user operates an information terminal to access a web application for remote timer-recording. A recorder apparatus at home timer-records the broadcast program.

2. Before watching a broadcast program, a user operates an information terminal to obtain an application, which functions as a remote control. The remote control controls operations (such as play, pause, and stop) when the user watches a broadcast program. The user operates the information terminal to start the obtained application.

3. A user operates an information terminal to start an application for posting a comment such as an opinion or a feedback about a broadcast program on an SNS site.

4. To go off to a concert, a user operates an information terminal to obtain an application for booking and buying a ticket for the concert. The user operates the information terminal to start the obtained application.

5. A user operates an information terminal to obtain an application for searching for a transportation and a route to a concert venue. The user operates the information terminal to start the obtained application.

6. A user operates an information terminal to obtain an application for booking and buying a ticket for the transportation such as an airplane or a train. The user operates the information terminal to start the obtained application.

In the above-mentioned usage examples, for example, the usage examples 1 to 3 relate to a certain broadcast program as an event. The usage examples 4 to 6 relate to a certain concert as an event.

Meanwhile, the time of an event such as a broadcast program or a concert is scheduled. An application, which relates to such an event, has particular available hours depending on an event type.

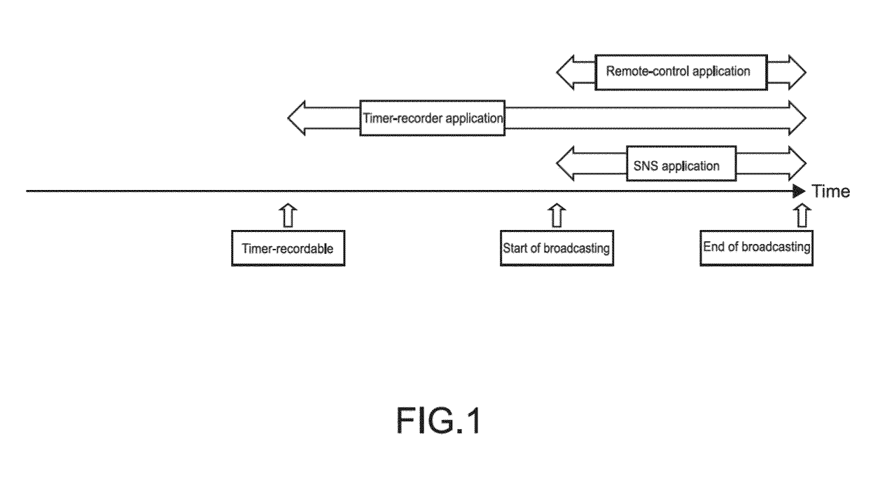

For example, as shown in FIG. 1, a timer-recorder application is capable of timer-recording a target broadcast program only when the timer-recorder application is capable of obtaining information necessary for timer-recording the target broadcast program. Further, a remote-control application for operation when a user watches a broadcast program should be started during broadcasting hours of a target broadcast program. Similarly, an application for posting on an SNS site should be started during broadcasting hours of a target broadcast program at the latest. Further, although not shown in FIG. 1, an application for booking and buying a ticket for a concert should be started during booking hours and sales hours of a ticket for a target concert.

As described above, an application, which relates to an event, has an available hours.

However, an information terminal starts an application entirely depending on a user's decision. Because of this, a user may forget to timer-record a target broadcast program even when the application is capable of timer-recording the target broadcast program. Further, a user may forget to watch the target broadcast program. A user may forget to book or buy a ticket for a concert similarly.

In view of the above-mentioned circumstances, it is desirable to provide a server apparatus for recommending an information terminal that the information terminal execute one or more applications, which relate to an event in which a user wishes to join, at timings when the applications are available, respectively.

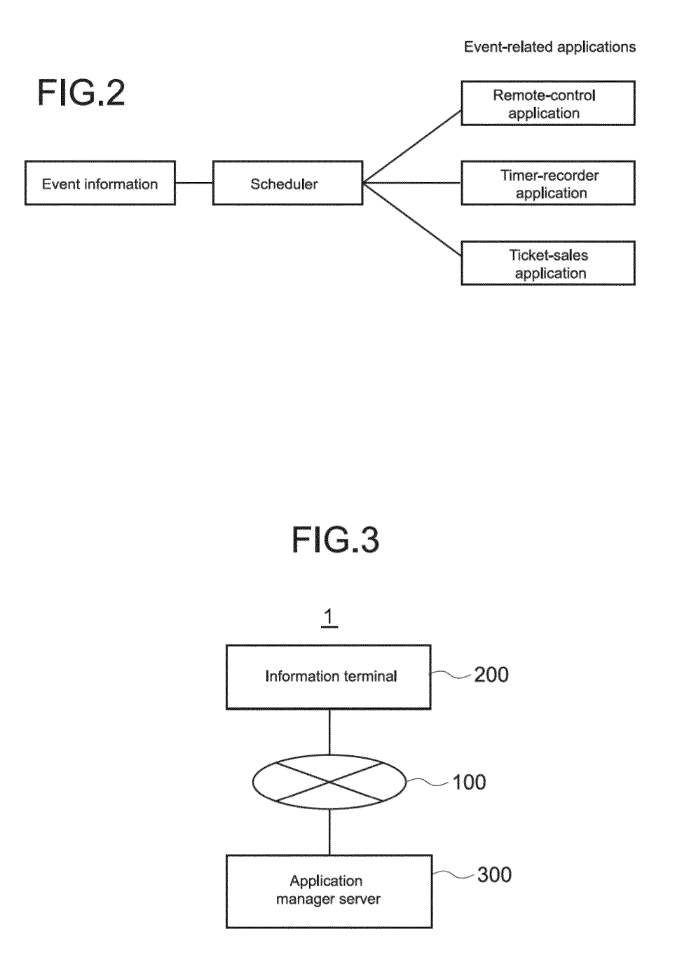

More specifically, for example as shown in FIG. 2, a server apparatus manages a relation of event information, one or more applications, and a scheduler application. The event information identifies an event. The one or more applications (hereinafter referred to as “event-related applications”) relates to the event. Hereinafter, the scheduler application is simply referred to as “scheduler”.

The scheduler is an application, which causes an information terminal to recommend to a user that an information terminal execute one or more event-related applications relating to an event at available timings of the event-related applications.

A server apparatus receives event information from an information terminal. The event information identifies an event, in which a user of the information terminal wishes to join. The server apparatus supplies a scheduler to the information terminal, which the user owns. The scheduler is connected to the event information. Based on the scheduler, the information terminal explicitly recommends one or more event-related applications, which relate to an event in which the user wishes to join, to the user at available timings of the one or more event-related applications, respectively.

Hereinafter, embodiments of the present technology will be described with reference to the drawings.

### [Configuration of Information Processing System]

FIG. 3 is a diagram showing the configuration of an information processing system 1 of this embodiment.

As shown in FIG. 3, the information processing system 1 of this embodiment includes a network 100, an information terminal 200, and an application manager server 300. The network 100 is, for example, the Internet. The information terminal 200 and the application manager server 300 are configured to connect to the network 100.

The information terminal 200 is configured to accept a designated event, in which a user wishes to join. The information terminal 200 is configured to send information (event information), which relates to the event, to the application manager server 300 via the network 100. Here, there are various events, in which a user wishes to join. However, for ease of explanation, the event is limited to a broadcast program and description will be made.

The application manager server 300 manages information by using an application-manager table. The information relates to applications (event-related applications), which are capable of being executed by the information terminal 200. Further, the application manager server 300 is configured to supply a scheduler application (hereinafter sometimes simply referred to as “scheduler”) to the information terminal 200 via the network 100. The scheduler causes the information terminal 200 to recommend to a user of the information terminal 200 that the information terminal 200 execute one or more event-related applications, which relate to an event in which a user wishes to join, at available timings of the event-related applications, respectively, based on the application-manager table and based on the event information obtained from the information terminal 200 via the network 100.

### [Functional Configuration of Information Terminal 200]

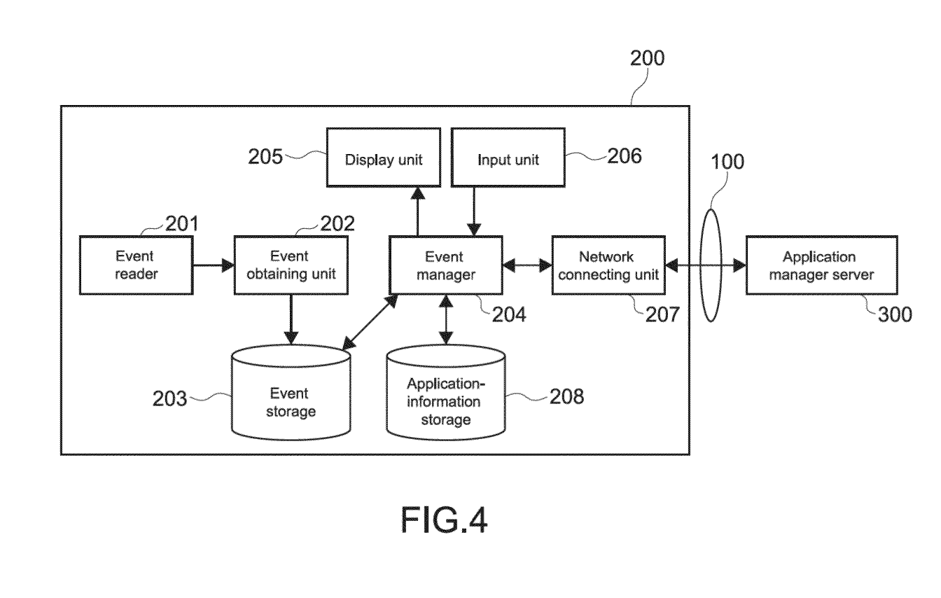

FIG. 4 is a block diagram showing the functional configuration of the information terminal 200.

The information terminal 200 includes an event reader 201, an event obtaining unit 202, event storage 203, an event manager 204, a display unit 205, an input unit 206, a network connecting unit 207, and application-information storage 208. Programs in storage are loaded into memory, and a CPU (Central Processing Unit) interprets and executes the programs, to thereby implement the event obtaining unit 202 and the event manager 204. The event storage 203 and the application-information storage 208 are set in rewritable nonvolatile memory.

The event reader 201 includes, for example, an image pickup device. The event reader 201 picks up an image of a QR (Quick Response) code (registered trademark). The event reader 201 supplies image-pickup data to the event obtaining unit 202.

The event obtaining unit 202 recognizes event information from a QR code (registered trademark). The QR code is included in the image-pickup data obtained from the event reader 201. The event obtaining unit 202 records the event information in the event storage 203.

Here, “event information” is various basic information, which relates to a broadcast program (event). More specifically, the event information includes a title, an event ID, start date/time, ending date/time, a channel, an event type, a content ID, a program URL, a broadcast station URL, and the like.

In those event-information elements, “event ID” is an ID uniquely identifying an event. For example, the same event ID is given to broadcast programs whose title is the same, irrespective of their start date/time.

“Event type” is information for identifying an event type (for example, broadcast program, concert, cinema, or the like). For example, an event type “TV” is given to all the broadcast programs.

“Content ID” is an ID uniquely identifying a broadcast program. For example, different content IDs are given to broadcast programs, whose title is the same (same event ID) but broadcasting hours are different.

“Program URL” is a URL of a web page, which opens information on a broadcast program to the public.

“Broadcast station URL” is a URL of a web page of a broadcast station.

The QR code (registered trademark) including such event information is provided by a event provider such as, for example, a broadcast station, or the like. The QR code (registered trademark) is included in, for example, a website, a magazine, a newspaper, an advertisement, a signboard, or the like.

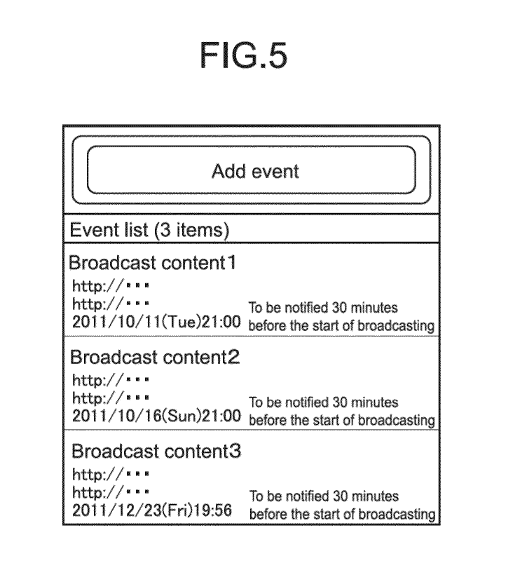

The event manager 204 detects a predetermined operation-input for displaying an event list on the input unit 206 from a user. Then, the event manager 204 reads event information recorded in the event storage 203. The event manager 204 creates an event list based on the read event information. The event manager 204 causes the display unit 205 to display the event list as shown in FIG. 5, for example.

Here, “event list” is a list of the events recorded in the event storage 203. The event list includes a title, broadcasting start date/time, a program URL, a broadcast station URL, and the like.

A user operates the input unit 206 such as, for example, a touchscreen, buttons, a mouse, or a keyboard. The user is capable of selecting an event, in which the user wishes to join, (i.e., broadcast program, which user wishes to watch) from an event list displayed on the display unit 205. The event manager 204 detects an operation-input into the input unit 206. The event manager 204 determines an event selected by a user. The event manager 204 reads information on the event, which is selected by the user, from the event storage 203. The event manager 204 sends information for identifying the event to the application manager server 300 by using the network connecting unit 207. The information includes an event type, start date/time, ending date/time, and the like. The event type, the start date/time, the ending date/time, and the like are in the event information, which are read from the event storage 203.

The event manager 204 receives information, which relates to one or more event-related applications relating to the event, and information, which relates to the scheduler. The event manager 204 receives the information as a reply from the application manager server 300, which received sent information identifying the event. The event manager 204 stores the information, which relates to one or more event-related applications relating to the event, and the information, which relates to the scheduler, in the application-information storage 208. After that, the information, which relates to one or more event-related applications, and the information, which relates to the scheduler, stored in the application-information storage 208 are referred to as “event-related application/scheduler information”.

The event manager 204 reads a URL from the event-related application/scheduler information stored in the application-information storage 208. The URL is location information, from which the event manager 204 obtains a scheduler. The event manager 204 accesses the URL, downloads the scheduler, and starts the scheduler.

The scheduler recommends to a user of the information terminal 200 that the information terminal 200 start one or more event-related applications, which are included in the event-related application/scheduler information, at available timings of the event-related applications, respectively. Further, the scheduler creates GUI (Graphical User Interface) information for accepting an event-related application to be started, which is selected by a user. The scheduler displays the GUI information on the display unit 205. How the scheduler works will be described later in detail.

Further, event details such as broadcasting hours of a broadcast program and holding hours of a concert may be changed suddenly. In view of this, the event manager 204 accesses the application manager server 300 at regular time intervals with regard to the event-related application/scheduler information recorded in the application-information storage 208. The event manager 204 makes an inquiry whether the event-related application/scheduler information is updated or not. If the event-related application/scheduler information is updated, the event manager 204 obtains the updated event-related application/scheduler information. The event manager 204 changes the information, which is stored in the application-information storage 208, by rewriting the updated event-related application/scheduler information. As a result, it is possible to deal with changes of event details such as broadcasting hours of a broadcast program and holding hours of a concert.

### [Functional Configuration of Application Manager Server 300]

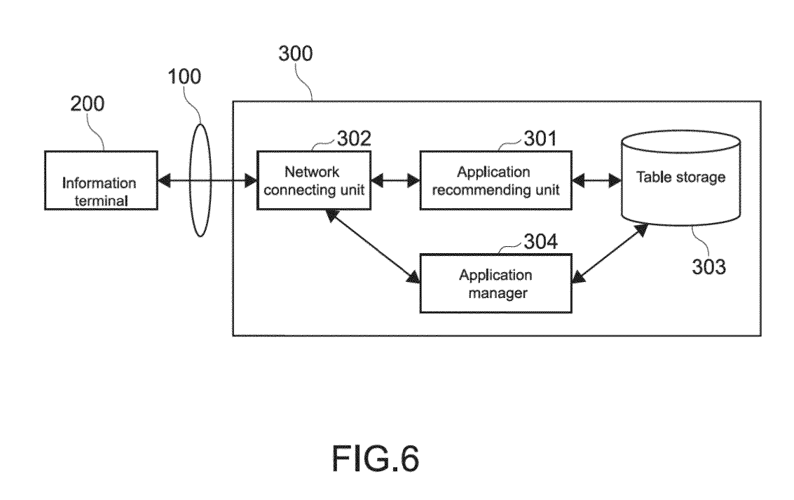

FIG. 6 is a block diagram showing the functional configuration of the application manager server 300.

The application manager server 300 includes an application recommending unit 301, a network connecting unit 302, table storage 303, and an application manager 304. Programs in storage are loaded into memory, and a CPU interprets and executes the programs, to thereby implement the application recommending unit 301 and the application manager 304. The table storage 303 is set in rewritable nonvolatile memory.

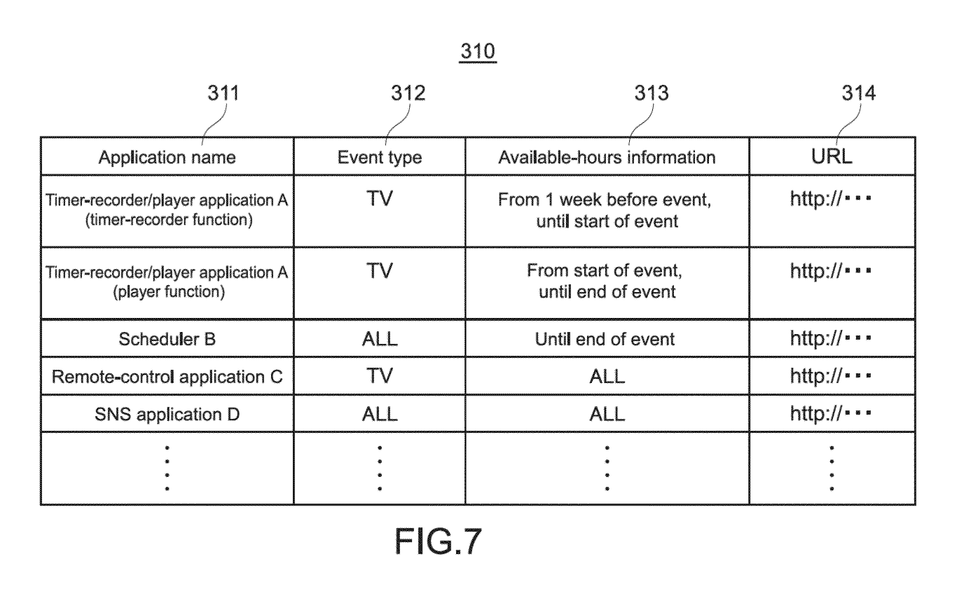

The application manager 304 manages information on applications (event-related applications, scheduler), which the information terminal 200 is capable of executing, by using an application-manager table 310 (FIG. 7).

The application recommending unit 301 selects one or more event-related applications, which relates to the event, and a scheduler based on information for identifying an event and based on the application-manager table 310. The information for identifying an event is obtained from the information terminal 200 by using the network connecting unit 302. The information for identifying an event includes an event type, start date/time, and ending date/time, and the like. The application-manager table 310 is stored in the table storage 303. The application recommending unit 301 sets procedures of the scheduler.

FIG. 7 is a diagram showing an example of the application-manager table 310.

As shown in FIG. 7, information relating to applications (event-related applications, scheduler), which the information terminal 200 is capable of executing, is recorded in the application-manager table 310. As such information, an application name 311, an event type 312, available-hours information 313, a URL 314, and the like are recorded in relation with each other.

In this example, as the event type 312, “TV” is set for “timer-recorder/player application A” and “remote-control application C”. “TV” indicates that an application relates to broadcast programs. Further, as the event type 312, “ALL” is set for “scheduler B” and “SNS application D”. “ALL” indicates that an application is available for all events.

The available hours 313 are information on application-available hours. For example, “from 1 week before event, until start of event” is set for “timer-recorder/player application A (timer-recorder function)” as the available hours. “From start of event, until end of event” is set for “timer-recorder/player application A (player function)” as the available hours. “Until end of event” is set for “scheduler B” as the available hours. “ALL” is set for “remote-control application C” and “SNS application D” as the available hours. The available hours “ALL” indicates that an application is always available.

The URL 314 is location information for downloading an application.

Here, how the application recommending unit 301 selects an application will be described.

First, the application recommending unit 301 compares an event type, which is obtained from the information terminal 200, with the event type 312 in the application-manager table 310. The application recommending unit 301 selects applications, for which the event type same as the event type obtained from the information terminal 200 is set, and applications, for which the event type “ALL” is set, from the application-manager table 310. For example, the application recommending unit 301 obtains the event type “TV” from the information terminal 200. In this case, the application recommending unit 301 selects applications, for which the event type “TV” and “ALL” are set. In the example of FIG. 7, the application recommending unit 301 selects “timer-recorder/player application A”, “scheduler B”, “remote-control application C”, and “SNS application D”.

Further, the application recommending unit 301 sets the start date/time and the ending date/time, which are obtained from the information terminal 200 as event-identifying information. The application recommending unit 301 sets procedures as content of “scheduler B” based on information, which relates to the above-mentioned determined event-related application.

The application recommending unit 301 extracts application names, event types, available hours, URLs, and the like of the respective selected one or more event-related applications and scheduler from the application-manager table 310. The application recommending unit 301 sends the extract information to the information terminal 200 by using the network connecting unit 302.

### [Scheduler]

Next, a scheduler will be described. A scheduler is a program for causing the information terminal 200 to recommend a user of the information terminal 200 that the information terminal 200 execute one or more event-related applications, which relate to an event in which a user wishes to join, at available timings of the event-related applications, respectively.

More specifically, the scheduler causes the information terminal 200 to display a selection window on the information terminal 200. The selection window includes options corresponding to one or more event-related applications, which relates to an event in which a user wishes to join. The scheduler causes the information terminal 200 to display, in an active state, options corresponding to event-related applications available at the present moment. The scheduler causes the information terminal 200 to display, in an inactive state, options corresponding to event-related applications unavailable at the present moment. Further, in a case where there are a plurality of event-related applications available at the present moment, the scheduler causes the information terminal 200 to number the plurality of event-related applications according to priority. The scheduler causes the information terminal 200 to explicitly display the priority numbers.

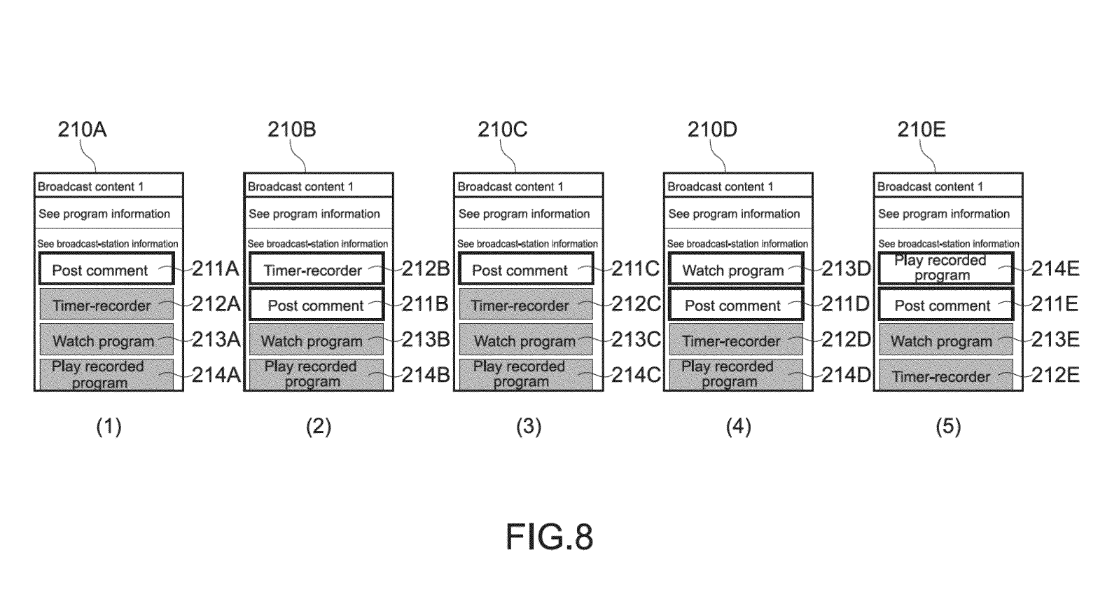

FIG. 8 shows that the state of selection window 210A to 210E changes over time from left to right. In each selection window 210A to 210E, “post comment” 211A to 211E, which is one of the options, is an option for selecting “SNS application D”. “Timer-recorder” 212A to 212E is an option for selecting “timer-recorder/player application A (timer-recorder function)”. “Watch program” 213A to 213E is an option for selecting “remote-control application C”. “Play recorded program” 214A to 214E is an option for selecting “timer-recorder/player application A (player function)”.

(1) shows a state more than 1 week before the event start date/time. Based on the scheduler, the event manager 204 highlights the option 211A corresponding to “SNS application D” by, for example, changing colors, activates the option 211A (i.e., makes the option 211A selectable), and displays the option 211A at the top. Further, the event manager 204 inactivates the options 212A, 213A, and 214A, which correspond to the other event-related applications (i.e., makes the options 212A, 213A, and 214A unselectable).

(2) shows a state from 1 week before the event start date/time to immediately before the start of the event. Based on the scheduler, the event manager 204 activates the option 211B corresponding to “SNS application D” and the option 212B corresponding to “timer-recorder/player application A (timer-recorder function)”. In this example, the priority number relation of “SNS application D” and “timer-recorder/player application A (timer-recorder function)” is as follows. That is, “timer-recorder/player application A (timer-recorder function)” is the 1st priority, and “SNS application D” is the 2nd priority. Here, the priority numbers are determined based on event types. For example, a priority number, which is lower than a priority number set to “TV”, is preset to “ALL”. “TV” is the event type of “timer-recorder/player application A (timer-recorder function)”. “ALL” is the event type of “SNS application D”.

Here, a user selects “timer-recorder” 212B, which is an option corresponding to “timer-recorder/player application A (timer-recorder function)”. Then, the event manager 204 starts “timer-recorder/player application A (timer-recorder function)”. If “timer-recorder/player application A (timer-recorder function)” is not stored in the information terminal 200, the event manager 204 reads a URL, which is location information from which the event manager 204 obtains “timer-recorder/player application A (timer-recorder function)”, from the application/scheduler information stored in the application-information storage 208. The event manager 204 accesses the URL, downloads “timer-recorder/player application A (timer-recorder function)”, and starts “timer-recorder/player application A (timer-recorder function)”.

(3) shows a state from timer-recording to immediately before the start of the event. Based on the scheduler, the event manager 204 inactivates the option 212C corresponding to “timer-recorder/player application A (timer-recorder function)”, and moves the option 212C immediately below the option 211C corresponding to “SNS application D”.

(4) shows a state from immediately before the start of the event to the end of the event. Based on the scheduler, the event manager 204 activates the option 213D corresponding to “remote-control application C”, and displays the option 213D at the top. Further, the event manager 204 displays the option 211D corresponding to “SNS application D” at the second top. Note that, based on the scheduler, the event manager 204 may display an alert on the display unit 205 a predetermined time before the event start date/time (for example, 30 minutes before the event start date/time). In this manner, the event manager 204 notifies a user that the event will start soon.

(5) shows a state after the end of the event. Based on the scheduler, the event manager 204 inactivates the option 212E corresponding to “remote-control application C”, and further lowers the display position of the option 212E. Based on the scheduler, the event manager 204 activates the option 214E corresponding to “timer-recorder/player application A (player function)”, and moves the option 214E upper than the option 211E corresponding to “SNS application D”.

### [Behaviors]

Next, how the information terminal 200 and the application manager server 300 work will be described.

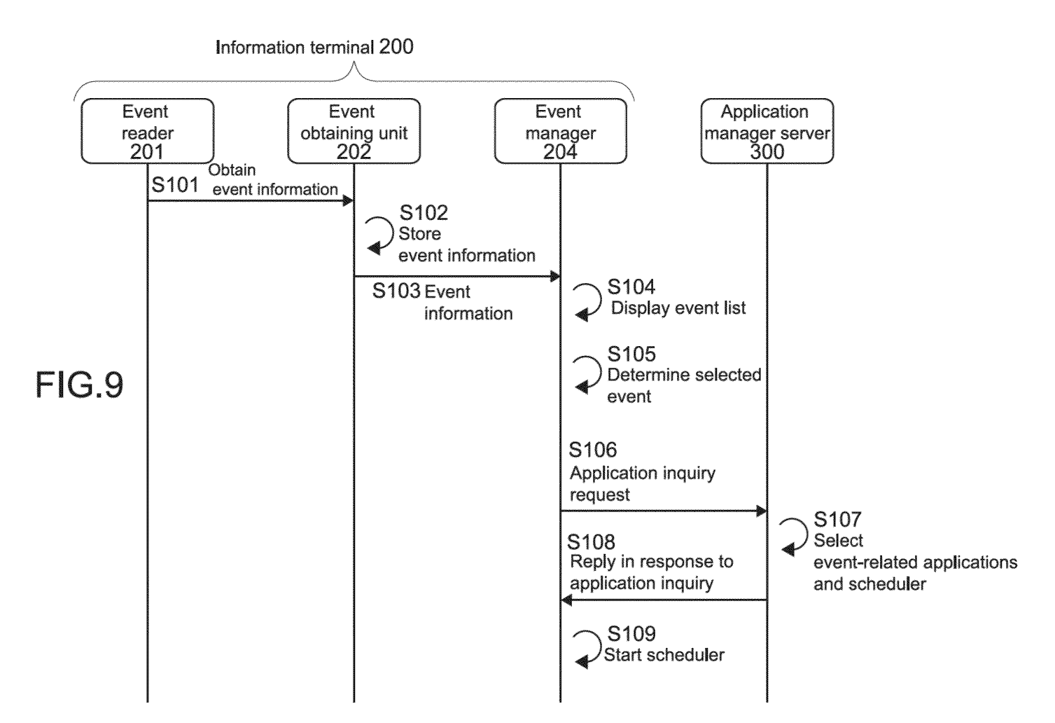

FIG. 9 is a sequence diagram showing how the information terminal 200 and the application manager server 300 work.

The event reader 201 of the information terminal 200 picks up an image of a QR code (registered trademark). The event reader 201 sends the image-pickup data to the event obtaining unit 202 (Step S101). The event obtaining unit 202 recognizes event information from the QR code (registered trademark), which is included in image-pickup data obtained by the event reader 201. The event obtaining unit 202 stores the event information in the event storage 203 (Step S102).

The event manager 204 detects a predetermined operation-input for displaying an event list from a user in the input unit 206. Then, the event manager 204 reads event information recorded in the event storage 203 (Step S103). The event manager 204 creates an event list based on the event information. The event manager 204 displays the event list on the display unit 205 (Step S104). Here, a user may operate the input unit 206, to thereby select an event, in which the user wishes to join, from the event list displayed on the display unit 205. The event manager 204 determines an event selected from the event list by the user (Step S105). Then, the event manager 204 reads information, which identifies the event, from the event storage 203. The information includes an event type of the event, start date/time of the event, ending date/time of the event, and the like. The event manager 204 sends an application inquiry request, which includes the read information, to the application manager server 300 by using the network connecting unit 207 (Step S106).

The application recommending unit 301 of the application manager server 300 receives the application inquiry request from the information terminal 200 by using the network connecting unit 302. The application recommending unit 301 selects one or more event-related applications, which relate to the event, and the scheduler, based on the information identifying the event and based on the application-manager table 310. The information identifying the event is included in the received application inquiry request, and includes the event type, the start date/time, the ending date/time, and the like. The application-manager table 310 is stored in the table storage 303. The application recommending unit 301 sets procedures of the scheduler (Step S107).

The application recommending unit 301 extracts information on the selected one or more event-related applications and scheduler from the application-manager table 310. The information includes application names, event types, available hours, URLs, and the like. The application recommending unit 301 sends the extracted information as event-related application/scheduler information to the information terminal 200 by using the network connecting unit 302 (Step S108).

The event manager 204 of the information terminal 200 receives the event-related application/scheduler information from the application manager server 300 by using the network connecting unit 207. Then, the event manager 204 records the event-related application/scheduler information in the application-information storage 208. The event manager 204 reads the URL of the scheduler from the received event-related application/scheduler information. The event manager 204 accesses the URL, downloads the scheduler, and starts the scheduler.

According to this embodiment, based on the scheduler, the information terminal 200 is capable of explicitly recommending one or more event-related applications, which relate to a certain event in which a user wishes to join, to a user at available timings of the event-related applications. As a result, for example, a user may not forget to timer-record a target broadcast program when the application is capable of timer-recording the target broadcast program. Further, a user may not forget to watch the target broadcast program.

Further, more specifically, the scheduler causes the information terminal 200 to display options corresponding to the one or more event-related applications, which relate to an event in which a user wishes to join. The scheduler causes the information terminal 200 to display options, which correspond to event-related applications available at the present moment, in active states, for example. As a result, a user may recognize event-related applications unavailable at the present moment.

Further, in a case where there are a plurality of event-related applications available at the present moment, the scheduler causes the information terminal 200 to set priority numbers for the plurality of event-related applications, and to display the priority numbers explicitly. As a result, a user may intuitively recognize applications available at the present moment, and the priority numbers set for the applications.

### [Hardware Configuration of Information Terminal 200 and Application Manager Server 300]

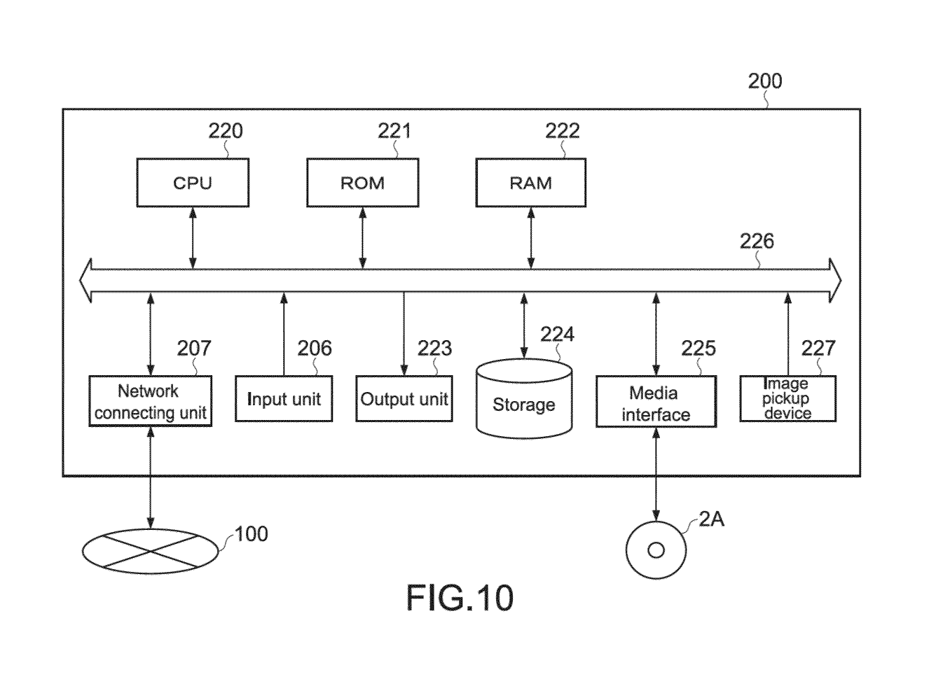

FIG. 10 is a block diagram showing the hardware configuration of the information terminal 200.

The information terminal 200 includes a CPU 220, a ROM 221, and a RAM 222. Further, the information terminal 200 includes the input unit 206, an output unit 223, storage 224, a media interface 225, the network connecting unit 207, an image pickup device 227, and a bus 226 connecting them.

The CPU 220 functions as an arithmetic processing unit and a controller unit. The CPU 220 controls the overall behaviors of the information terminal 200 based on various programs. The ROM 221 stores programs, arithmetic parameters, and the like that the CPU 220 uses. The RAM 222 temporally stores programs executed by the CPU 220, parameters that change arbitrarily when the CPU 220 executes the programs, and the like.

The input unit 206 includes an input unit, an input control circuit, and the like. The input unit includes, for example, a mouse, a keyboard, a touchscreen, buttons, a microphone, a switch, a lever, and the like. A user input information in the input unit. The input control circuit creates input signals based on inputs from a user, and outputs the signals to the CPU 220. A user of the information terminal 200 operates the input unit 206. As a result, the user may input various data in the CPU 220, and input processing/operation instructions in the CPU 220.

The output unit 223 includes the display unit 205. The display unit 205 is, for example, a CRT (Cathode Ray Tube) display unit, an LCD (Liquid Crystal Display) unit, an OLED (Organic Light Emitting Diode) unit, or the like. Further, the output unit 223 includes a sound output unit such as a speaker or a headphone.

The storage 224 stores programs and user data. The storage 224 includes a storage medium, a reader/writer, and the like. The reader/writer reads/writes data from/in the storage medium. The storage 224 is, for example, an HDD (Hard Disk Drive), an SSD (Solid State Drive), or the like.

The media interface 225 is a reader/writer for a storage medium. The media interface 225 reads/writes data from/in a removal storage medium 2A, which is mounted on the information terminal 200. Examples of the removal storage medium 2A include a magnetic disk, an optical disk, a magnet-optical disk, a semiconductor memory, and the like.

The network connecting unit 207 is an interface for connecting to the network 100, for example. The network connecting unit 207 may be a wireless LAN (Local Area Network)-compliant device, a wireless USB-compliant device, or a wire communication device for performing wire communication.

The image pickup device 227 includes an imaging element. Examples of the imaging element include, for example, a CMOS (Complementary Metal Oxide Semiconductor), a CCD (Charge Coupled Devices) sensor, and the like. The imaging element picks up still images (photographs) and moving images.

Note that the information terminal 200 may be of any specific product type as long as the information terminal 200 at least includes hardware elements shown in FIG. 10. Examples of the information terminal 200 include a smartphone, a tablet computer, a mobile phone, a personal computer, a PDA (Personal Digital Assistant), a television receiver, and the like.

The application manager server 300 has the hardware configuration same as the hardware configuration of the information terminal 200 except that the application manager server 300 does not include the image pickup device 227.

### Second Embodiment

Hereinafter, configurations and functions similar to those of the first embodiment will be denoted by similar reference symbols, description thereof will be omitted, and different points will be described.

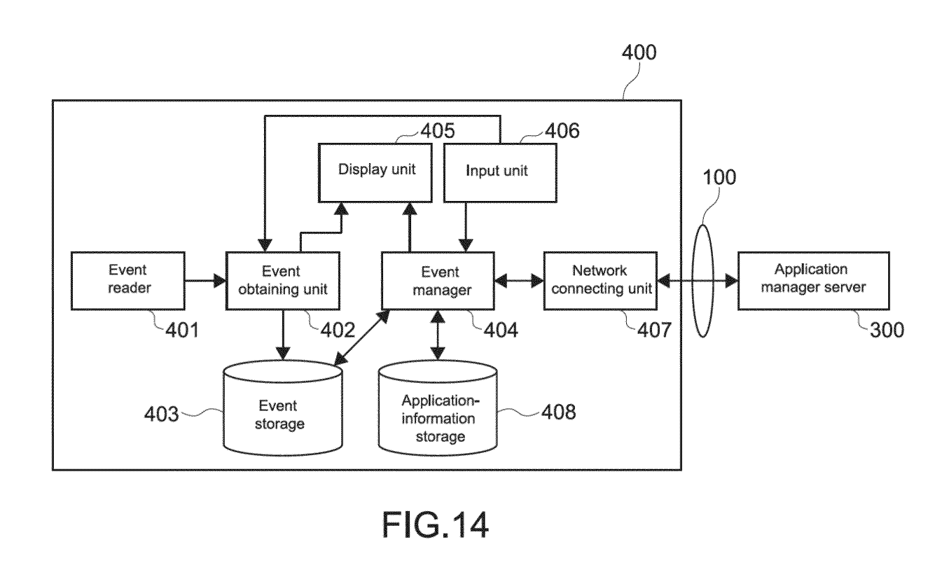

FIG. 14 is a block diagram showing the functional configuration of an information terminal 400 according to a second embodiment.

An event obtaining unit 402 of the information terminal 400 of the second embodiment is configured to recognize event information input from an input unit 406 operated by a user. The event obtaining unit 402 is configured to record the event information in event storage 403. Here, event information input by a user is user's personal schedule information such as a plan to go out or a future goal. Specifically, a user inputs the following event information by means of the input unit 406. Examples of the event information include a destination name (restaurant name, etc.), planned date/time to go to the destination, an event type, and the like. Alternatively, a user inputs the following event information by means of the input unit 406. Examples of the event information include a future goal (money-savings goal, weight goal, etc.), planned date/time when the future goal is to be achieved, an event type, and the like. Here, a user may input an event type as follows. That is, the event obtaining unit 402 displays a window for selecting an event type from a plurality of event types on a display unit 405. A user selects an event type by means of the input unit 406. Note that the plurality of event types for selecting an event type, which are displayed on the display, relate to user's personal schedule information. For example, the plurality of event types are “eating-out”, “money-savings”, “weight-loss”, and the like.

Meanwhile, information on applications, as the application-manager table 310 (FIG. 7), is recorded also in the table storage 303 of the application manager server 300 of the second embodiment. The applications relate to event types, respectively. The event types relate to user's personal schedule information such as, for example, “eating-out”, “money-savings”, and “weight-loss”. For example, as event-related applications in relation to the event type “eating-out”, a route-search application, a gourmet word-of-mouth posting application, a restaurant search application, and the like are registered in the table storage 303. As event-related applications in relation to the event type “money-savings”, an Internet banking application, a money-savings-assist application, and the like are registered in the table storage 303. As event-related applications in relation to the event type “weight-loss”, an calorie-counter application, a weight-loss-assist application, and the like are registered in the table storage 303. Further, as available hours for those event-related applications, for example, “until planned date/time of event” is set.

The application recommending unit 301 selects one or more event-related applications, which relates to a certain event, and a scheduler, based on information identifying an event, and based on the application-manager table 310 stored in the table storage 303. Examples of the information identifying an event include an event type, planned date/time (corresponding to “start date/time” of first embodiment.), and the like, which are obtained from the information terminal 400 by means of the network connecting unit 302. In addition, the application recommending unit 301 sets procedures of the scheduler.

For example, the application recommending unit 301 sets procedures of the scheduler as follows. Here, procedures about event-related applications in relation to an event whose event type is “eating-out” will be described as an example.

The scheduler causes the information terminal 200 to behave as follows. That is, the information terminal 200 recommends to a user of the information terminal 200 that the information terminal 200 execute one or more event-related applications (route-search application, gourmet word-of-mouth posting application, restaurant search application, etc.) in relation to an event whose event type is “eating-out” at available timings of the event-related applications. Specifically, the scheduler activates event-related applications from more than 1 week before the planned date/time of an event to 1 week before the planned date/time. At the same time, the scheduler sets priorities as follows. That is, an gourmet word-of-mouth posting application is the 1st priority, a restaurant search application is the 2nd priority, and a route-search application is the 3rd priority. Then, the scheduler maintains the active state of the event-related applications from 1 week before the planned date/time of the event to the planned date/time of the event. At the same time, the scheduler sets priorities as follows. That is, the route-search application is the 1st priority. The scheduler puts off the priority numbers of the other event-related applications.

### MODIFIED EXAMPLES

In the above-mentioned embodiments, the event reader 201 of the information terminal 200 may include an antenna and a non-contact IC chip such as, for example, FeliCa (registered trademark) chip. In this case, the event reader 201 communicates with a reader/writer (not shown). The reader/writer writes various information on broadcast programs. Alternatively, the event reader 201 may include both of an image pickup device and a non-contact communication system. Alternatively, the event reader 201 may include any one of an image pickup device and a non-contact communication system.

According to the above-mentioned embodiments, the information terminal 200 displays an inactive option in a shaded status. Alternatively, an inactive option may not be displayed.

Further, the information terminal 200 may display both of active options and inactive options. The information terminal 200 may respond to operations for selecting the active options, and may not respond to operations for selecting the inactive options.

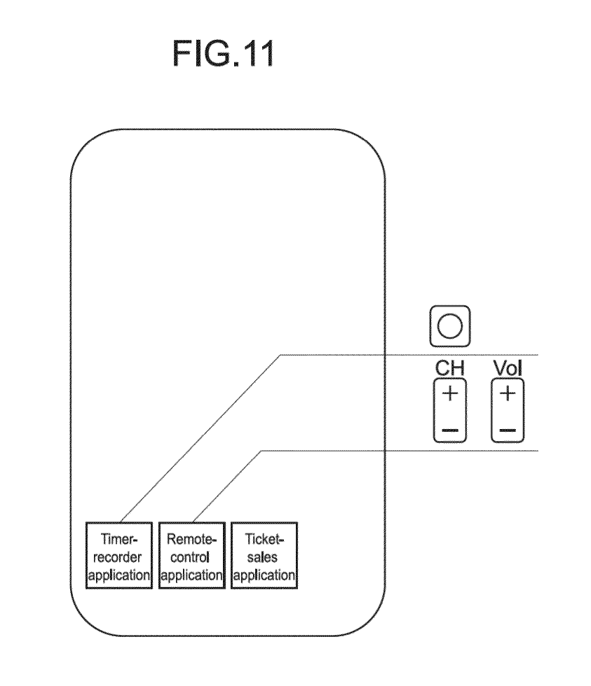

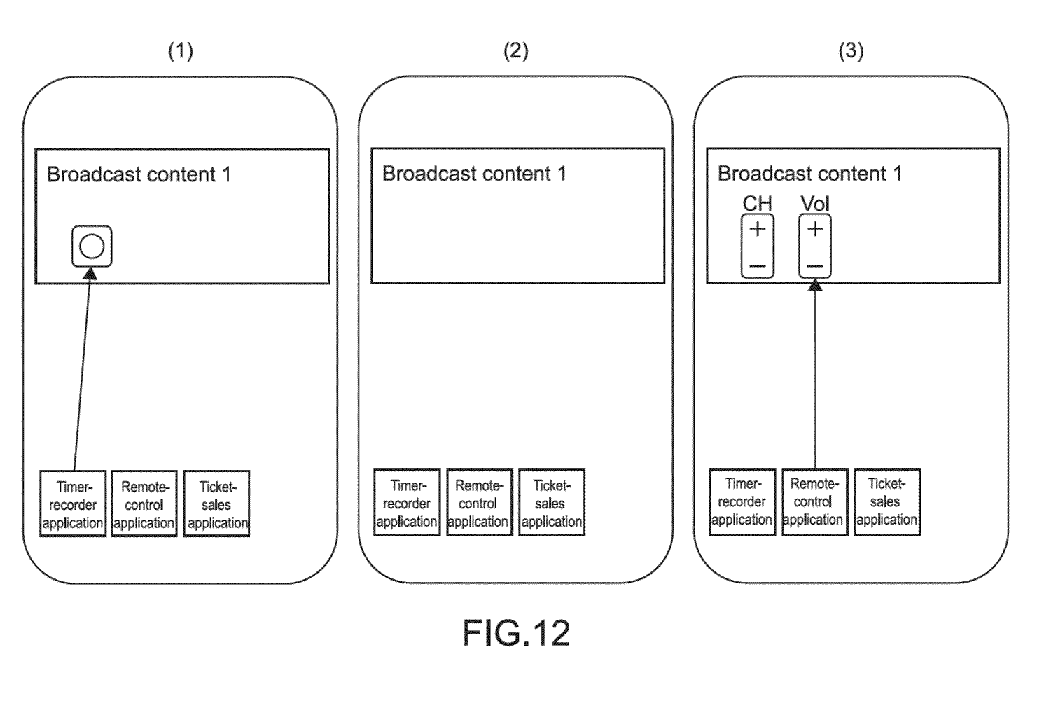

As shown in FIG. 11, the information terminal 200 may display a record-button image as an option for a timer-recorder application. The information terminal 200 may display a channel-operation button image and a volume-operation-button image as options for a remote-control application. In these cases, the event manager 204 detects an operation-input in each option. Then, the event manager 204 may execute a recorder function, a channel-operation function, a volume-operation function, or the like, which relates to the operated option in an application. More specifically, as shown in FIG. 12, the information terminal 200 may display the above-mentioned record button image, channel-operation button image, volume-operation button image, and the like during available hours of the event-related applications.

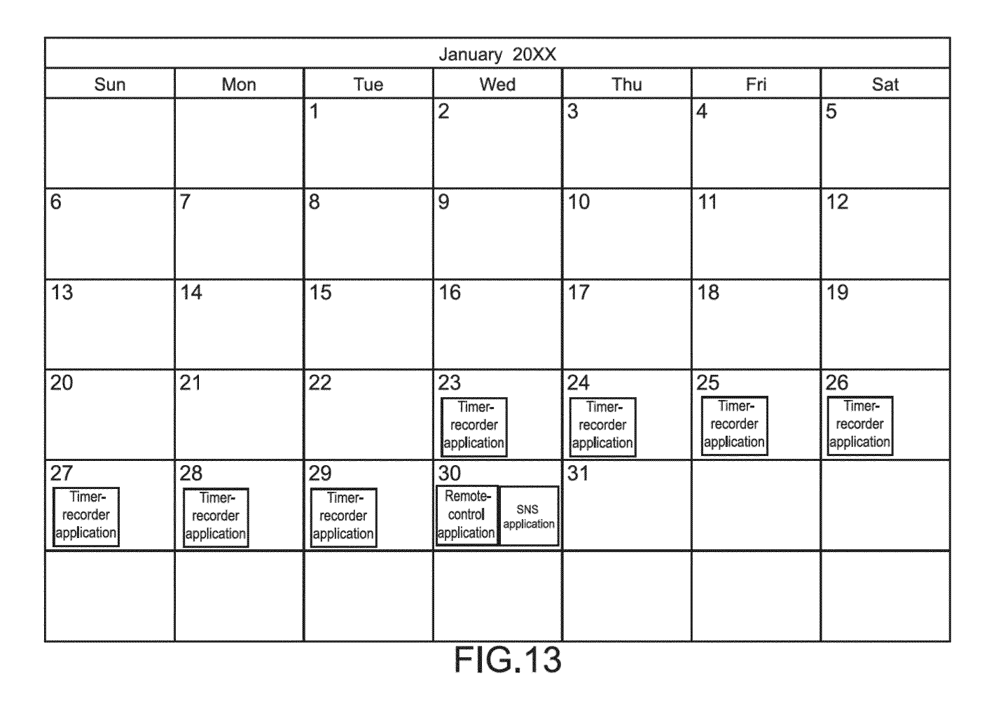

As shown in FIG. 13, available hours of the event-related applications may be mapped on a calendar and displayed.

A plurality of event-related applications may be displayed in relation to one option.

The scheduler may have the following function.

Available hours of an application is not decided because the date of an event is not decided. In this case, the information terminal notifies a user of that fact with information on a host of an event. Such information includes a URL of a web page, which will announce the date of the event and an email address.

The present technology may employ the following configurations.

(1) A server apparatus, comprising:

an event-information receiver configured to receive information from an information terminal, the information identifying an event in which a user of the information terminal wishes to join; and

an application recommending unit configured to recommend, when receiving the information identifying the event, to the user of the information terminal that the information terminal execute one or more event-related applications at timings when the event-related applications are available, respectively, the one or more event-related applications relating to the event in which the user wishes to join.

(2) The server apparatus according to (1), wherein

the application recommending unit is configured to provide a scheduler application to the information terminal, the scheduler application causing the information terminal to recommend, when receiving the information identifying the event, to the user of the information terminal that the information terminal execute one or more event-related applications at timings when the event-related applications are available, respectively, the one or more event-related applications relating to the event in which the user wishes to join.

(3) The server apparatus according to (1) or (2), wherein

the application recommending unit is configured
to send information on the one or more event-related applications and the scheduler application to the information terminal, and
to reply the scheduler application in response to an obtaining request from the information terminal.

(4) The server apparatus according to any one of (1) to (3), wherein

the scheduler application is a program causing the information terminal
to display options, the options corresponding to the one or more event-related applications, respectively, and
to display options in a manner that the user is capable of identifying the options, the options corresponding to an available event-related application.

(5) The server apparatus according to any one of (1) to (4), wherein

the scheduler application is a program causing the information terminal
to set, in a case where available hours of the plurality of event-related applications overlap one another, priority numbers for the plurality of event-related applications, and
to display the priority numbers explicitly.

The present disclosure contains subject matter related to that disclosed in Japanese Priority Patent Application JP 2011-261708 filed in the Japan Patent Office on Nov. 30, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A server apparatus, comprising:
an event-information receiver configured to receive information from an information terminal, the information identifying an event in which a user of the information terminal wishes to join; and
an application recommending unit configured to recommend, when receiving the information identifying the event, to the user of the information terminal that the information terminal execute one or more event-related applications at timings when the event-related applications are available, respectively, the one or more event-related applications relating to the event in which the user wishes to join.

2. The server apparatus according to claim 1, wherein
the application recommending unit is configured to provide a scheduler application to the information terminal, the scheduler application causing the information terminal to recommend, when receiving the information identifying the event, to the user of the information terminal that the information terminal execute one or more event-related applications at timings when the event-related applications are available, respectively, the one or more event-related applications relating to the event in which the user wishes to join.

3. The server apparatus according to claim 2, wherein
the application recommending unit is configured
to send information on the one or more event-related applications and the scheduler application to the information terminal, and
to reply the scheduler application in response to an obtaining request from the information terminal.

4. The server apparatus according to claim 3, wherein
the scheduler application is a program causing the information terminal
to display options, the options corresponding to the one or more event-related applications, respectively, and
to display options in a manner that the user is capable of identifying the options, the options corresponding to an available event-related application.

5. The server apparatus according to claim 4, wherein
the scheduler application is a program causing the information terminal
to set, in a case where available hours of the plurality of event-related applications overlap one another, priority numbers for the plurality of event-related applications, and
to display the priority numbers explicitly.

6. A program causing a computer to function as:
an event-information receiver configured to receive information from an information terminal, the information identifying an event in which a user of the information terminal wishes to join; and
an application recommending unit configured to recommend, when receiving the information identifying the event, to the user of the information terminal that the information terminal execute one or more event-related applications at timings when the event-related applications are available, respectively, the one or more event-related applications relating to the event in which the user wishes to join.

7. An information terminal, comprising:
an event-information sending unit configured to send information to a server apparatus, the information identifying an event in which a user of the information terminal wishes to join, the server apparatus including an application recommending unit, the application recommending unit being configured to recommend, when receiving the information identifying the event in which the user of the information terminal wishes to join from the information terminal, to the user of the information terminal that the information terminal execute one or more event-related applications at timings when the event-related applications are available, respectively, the one or more event-related applications relating to the event in which the user wishes to join; and
an application providing unit configured to provide information on the one or more event-related applications to the user, the one or more event-related applications being recommended by the server apparatus in response to sending of the information identifying the event in which the user wishes to join.
